(19) United States
(12) Patent Application Publication
(10) Pub. No.: US 2007/0021959 A1
(43) Pub. Date: Jan. 25, 2007

(54) Method and device for removing known acoustic signal

(75) Inventor: Masataka Goto, Tsukuba-shi (JP)

Correspondence Address: RANKIN, HILL, PORTER & CLARK LLP, 4080 ERIE STREET, WILLOUGHBY, OH, 44094-7836, US

(73) Assignee: National Institute of Advanced Industrial Science and Technology, Tokyo (JP)

(21) Appl. No.: 10/558,608

(22) PCT Filed: May 26, 2004
(86) PCT No.: PCT/JP04/07587

§ 371 Date: Jan. 5, 2006

(30) Foreign Application Priority Data
May 30, 2003 (JP) 2003-154964
Jun. 11, 2003 (JP) 2003-167118

(51) Int. Cl. G10L 15/20

(52) U.S. Cl. 704/233

(57) ABSTRACT

The present invention relates to a device for removing a known acoustic signal that enables removal of the known acoustic signal when mixed acoustic signals including a plurality of acoustic signals are entered and a known acoustic signal similar to one of the mixed acoustic signals is specified. This device converts an input mixed acoustic signal m(t) and a known acoustic signal b′(t) respectively into an amplitude spectrum M(ω,t) and B′(ω,t) in their respective time frequency areas, and then removes a component corresponding to B′(ω,t) included in the M(ω,t) by means of subtraction. Thus, an amplitude after removal S(ω,t) is obtained. Since the component corresponding to B′(ω,t) included in M(ω,t) has been deformed due to various factors such as a positional shift overtime, a temporal change in frequency characteristics, and a temporal change in volume, a corrected amplitude spectrum B(ω,t) is used in subtraction. Last, using a phase of m(t) and S (ω,t), inverse conversion into a time area is performed, thereby obtaining a desired acoustic signal after removal s(t).

### TECHNICAL FIELD

The present invention relates to a known acoustic signal removal method and a known acoustic signal removal device for removing a known acoustic signal component from a mixed acoustic signal with a plurality of acoustic signals mixed therein.

### BACKGROUND ART

The spectral subtraction method (Nonpatent Document 1) has been hitherto known as an acoustic signal processing. In the conventional spectrum subtraction method, a stationary noise is removed from an acoustic signal (mixed sound) in which the stationary noise (the noise of which the spectrum does not change in time, and of which the frequency characteristic, volume, and the like are substantially constant) is mixed with a desired sound (a target sound), thereby obtaining the target sound. In this method, the spectrum of the stationary noise is studied in advance using an easy method such as the one for obtaining an average stationary spectrum. Then, the spectrum of the stationary noise is subtracted from the spectrum of an input mixed sound. In other words, subtraction of the average of the noise is performed.

Generally, a lot of methods employing inputs from a plurality of microphones are proposed for acoustic signal removal. Various improvements have been made to the spectral subtraction method, as disclosed in Patent Documents 1 to 7.

[Nonpatent Document 1]

Steven Boll, “Suppression of Acoustic Noise in Speech Using Spectral Subtraction”, IEEE Transactions on Acoustics, Speech, and Signal Processing, Vol. ASSP-27, No. 2, April 1979.

[Patent Document 1]

Japanese Patent Application Laid-Open Publication No. 175099/2002

[Patent Document 2]

Japanese Patent Application Laid-Open Publication No. 014694/2002

[Patent Document 3]

Japanese Patent Application Laid-Open Publication No. 228892/2001

[Patent Document 4]

Japanese Patent Application Laid-Open Publication No. 215992/2001

[Patent Document 5]

Japanese Patent Application Laid-Open Publication No. 003094/1999

[Patent Document 6]

Japanese Patent Application Laid-Open Publication No. 240294/1998

[Patent Document 7]

Japanese Patent Application Laid-Open Publication No. 221092/1996

### DISCLOSURE OF THE INVENTION

The conventional spectrum subtraction method was constructed on an assumption that it would handle stationary noise, and could not be applied to a nonstationary noise (a noise of which the spectrum greatly changes over time and of which the frequency characteristic, volume, and the like also change). It was impossible to remove a nonstationary noise such as music used as a background music (BGM) that greatly changes over time. This is because the change in the spectrum of the nonstationary noise is too large to study.

Further, even if a condition in which the nonstationary noise is given in advance is to be dealt with by the conventional method, subtraction of the nonstationary noise could not be appropriately performed due to the influences of changes in the frequency characteristic, volume, or an expansion or contraction of the amplitude spectrum in a time axis direction as well as in a frequency axis direction. The method employing inputs from a plurality of microphones could not be applied to a monaural acoustic signal. Any of the improved conventional spectral subtraction could not be used for an application in which the nonstationary noise is given in advance and the removal of the nonstationary noise is to be performed, since these methods mainly aim at preprocessing of speech recognition.

Accordingly, an object of the present invention is to provide a known acoustic signal removal method, a known acoustic signal removal device, and a program used in this device by which a known (nonstationary or stationary) acoustic signal component can be removed from a mixed acoustic signal having a plurality of acoustic signals mixed therein, using a known acoustic signal from an original sound source corresponding to it.

Other object of the present invention is to provide a known acoustic signal removal method, a known acoustic signal removal device, and a program used in this device by which a background music (BGM) can be removed from a mixed sound, in which, for example, the known acoustic signal, indicative of music, is used as the BGM for a human voice or a sound in the mixed sound. The removal is performed using a known acoustic signal (e.g. the acoustic signal of the same music obtained separately from a CD, a record, or the like) from the original sound source, corresponding to the known acoustic signal.

A still another object of the present invention is to provide a known acoustic signal removal method, a known acoustic signal removal device, and a program used in this device which can automatedly estimate the accurate position of the known acoustic signal in the mixed sound and can remove the known acoustic signal at that position at the time of the removal of the known acoustic signal component from the acoustic signal (mixed sound) having a plurality of acoustic signals mixed therein.

A still another object of the present invention is to provide a known acoustic signal removal device equipped with an interface through which the accurate position of the known acoustic signal can be manually specified in the mixed sound at the time of the removal of the known acoustic signal component from the acoustic signal (mixed sound) having a plurality of acoustic signals mixed therein.

A still another object of the present invention is to provide a known acoustic signal removal method, a known acoustic signal removal device, and a program used in this device which can automatedly estimate temporal changes in the frequency characteristic and the volume of the known acoustic signal in the mixed sound and can remove those changes while correcting those changes, at the time of the removal of the known acoustic signal component from the acoustic signal (mixed sound), having a plurality of acoustic signals mixed therein.

A still another object of the present invention is to provide a known acoustic signal removal device equipped with an interface through which the temporal changes in the frequency characteristic and the volume of the known acoustic signal in the mixed sound can be manually specified at the time of the removal of the known acoustic signal component from the acoustic signal (mixed sound) having a plurality of acoustic signals mixed therein.

A still another object of the present invention is to provide a known acoustic signal removal method, a known acoustic signal removal device, and a program used in this device which can automatedly estimate an expansion or a contraction in the time axis or frequency axis direction of the known acoustic signal and can remove the expansion or the contraction while correcting the expansion or the contraction at the time of the removal of the known acoustic signal component from the acoustic signal (mixed sound) having a plurality of acoustic signals mixed therein.

A still another object of the present invention is to provide a known acoustic signal removal device equipped with the interface through which the expansion or the contraction in the time axis or frequency axis direction of the known acoustic signal in the mixed sound can be manually specified at the time of the removal of the known acoustic signal component from the acoustic signal (mixed sound) having a plurality of acoustic signals mixed therein.

A still another object of the present invention is to provide a known acoustic signal removal method, a known acoustic signal removal device, and a program used in this device which can repetitively remove a plurality of known acoustic signals one by one at the time of removal of a plurality of known acoustic signal components from the acoustic signal having a plurality of acoustic signals mixed therein.

In the known acoustic signal removal method of the present invention, a (nonstationary or stationary) known acoustic signal component is removed from a mixed acoustic signal having a plurality of acoustic signals mixed therein, using a known acoustic signal from an original sound source corresponding to it.

For this purpose, in the known acoustic signal removal method of the present invention, the mixed acoustic signal is first transformed into a time-frequency representation, thereby obtaining the amplitude spectrum of the mixed acoustic signal and the phase of the mixed acoustic signal (mixed acoustic signal transforming step). As a method for transforming the acoustic signal into a time-frequency representation, a publicly known transform method such as a Fourier Transform or a Wavelet Transform is employed.

Next, the known acoustic signal (separately obtained acoustic signal of the same music from a CD, a record, or the like) corresponding (or similar) to the known acoustic signal included in the mixed acoustic signal is transformed into a time-frequency representation, thereby obtaining the amplitude spectrum of the known acoustic signal (known acoustic signal transforming step).

Then, the corrected amplitude spectrum of the known acoustic signal is obtained (correction step) by correcting at least one of a positional shift over time, a temporal change in the frequency characteristic, a temporal change in the volume, an expansion or a contraction in the time axis direction, and an expansion or a contraction in the frequency axis direction of the amplitude spectrum of the known acoustic signal in relation to that of the mixed acoustic signal, based on the amplitude spectrum of the obtained mixed acoustic signal.

Next, the corrected amplitude spectrum of the known acoustic signal is removed from the amplitude spectrum of the mixed acoustic signal (removal step). An inverse transform into a time representation is performed, based on the amplitude spectrum after removal obtained by this removal step and the phase of the mixed acoustic signal, thereby obtaining unit waveforms (inverse transforming step).

Finally, the unit waveforms are synthesized using a synthesis method such as an overlap-add method, thereby obtaining an acoustic signal from which the known acoustic signal component has been removed (synthesis step).

In the known acoustic signal removal method of the present invention, by executing a correction step that will be described below, the corrected amplitude spectrum of the known acoustic signal is obtained, in which at least one of the positional shift over time, the temporal change in the frequency characteristic, the temporal change in the volume, the expansion or the contraction in the time axis direction, and the expansion or the contraction in the frequency axis direction of the amplitude spectrum of the known acoustic signal is corrected in relation to the amplitude spectrum of the mixed acoustic signal, and then, the corrected amplitude spectrum is removed from that of the mixed acoustic signal. For this reason, the known acoustic signal included in the mixed acoustic signal as nonstationary noise can be removed with high accuracy.

In principle, it is preferable to correct all of the phenomena or changes that actually occur in the mixed acoustic signal, in respect of the positional shift over time, the temporal change in the frequency characteristic, the temporal change in the volume, the expansion or the contraction in the time axis direction, and the expansion or the contraction in the frequency axis direction of the amplitude spectrum of the known acoustic signal.

However, when only one of the phenomena or changes that actually occur in the mixed acoustic signal is corrected, the removal accuracy of the known acoustic signal can be more enhanced than in a case where no correction is made. All phenomena or changes, therefore, do not need to be corrected. All phenomena or changes required for correction may be, of course, corrected.

In the execution of the correction step, a temporal position of the known acoustic signal included in the mixed acoustic signal is estimated, for example. Then, based on the estimated temporal position, the positional shift over time of the amplitude spectrum of the known acoustic signal is corrected. As the method of the estimation, a distance (or similarity) between each of the given segments of the amplitude spectrum of the mixed acoustic signal and each of the given segments of the amplitude spectrum of the known acoustic signal is obtained, for example. Then, the segment in which the distance is the smallest is estimated as the one showing the temporal position of the known acoustic signal included in the mixed acoustic signal.

In the execution of the correction step, a change in the frequency characteristic of the known acoustic signal included in the mixed acoustic signal is estimated, for example. Then, based on the estimated temporal change in the frequency characteristic, the temporal change in the frequency characteristic of the amplitude spectrum of the known acoustic signal is corrected. In the estimation of the change in the frequency characteristic, a segment including only the known acoustic signal in the mixed acoustic signal is specified. Then, the frequency characteristic in this segment is contrasted with that of the known acoustic signal corresponding to this segment, thereby estimating the change in the frequency characteristic of the known acoustic signal included in the mixed acoustic signal.

In the execution of the correction step, a temporal change in the volume of the known acoustic signal included in the mixed acoustic signal is estimated, for example. Then, based on the estimated temporal change in the volume, the temporal change in the volume of the amplitude spectrum of the known acoustic signal is corrected. In the estimation of the temporal change in the volume, after the correction of the frequency characteristic has been performed, a frequency band having an amplitude corresponding to that of the known acoustic signal included in the mixed acoustic signal, for example, is specified at each time. Then, the amplitude of the mixed acoustic signal is contrasted with that of the known acoustic signal in the frequency band, thereby performing the estimation.

In the execution of the correction step, an expansion or a contraction in the time axis direction of the known acoustic signal included in the mixed acoustic signal is estimated, for example. Then, based on the estimated expansion or contraction in the time axis direction, the expansion or the contraction in the time axis direction of the amplitude spectrum of the known acoustic signal is corrected. In the estimation of the expansion or the contraction in the time axis direction, a segment including only the known acoustic signal in the mixed acoustic signal is specified. Then, the time axis of this segment is contrasted with that of the known acoustic signal corresponding to this segment, thereby estimating the expansion or the contraction in the time axis direction. Alternatively, the estimation is performed by dividing the time axis into short segments, and contrasting all the segments.

In the execution of the correction step, an expansion or a contraction in the frequency axis direction of the known acoustic signal included in the mixed acoustic signal is estimated, for example. Then, based on the estimated expansion or contraction in the frequency axis direction, the expansion or the contraction in the frequency axis direction of the amplitude spectrum of the known acoustic signal is corrected. In the estimation of the expansion or the contraction in the frequency axis direction, a segment including only the known acoustic signal in the mixed acoustic signal is specified. Then, the frequency axis of the known acoustic signal is contrasted with that of the known acoustic signal in the segment corresponding to this segment, thereby performing the estimation.

In the known acoustic signal removal method of the present invention, an image display step of displaying an image may be further executed so that the amplitude spectrum of the mixed acoustic signal and that of the known acoustic signal can be visually recognized. In this case, a segment with the known acoustic signal in the mixed acoustic signal included therein is manually specified based on the image display. Then, the correction step, removal step, inverse transforming step, or synthesis step is executed on this segment.

In the known acoustic signal removal method of the present invention, the acoustic reproduction step of reproducing as sounds the mixed acoustic signal, the known acoustic signal, and an output signal resulting from the synthesis step may be further executed. In this case, a segment with the known acoustic signal in the mixed acoustic signal included therein is manually specified, based on the reproduced sounds resulting from the acoustic reproduction step. Then, the correction step, removal step, inverse transforming step, or synthesis step is executed on this segment.

In the known acoustic signal removal method of the present invention, it may also be so arranged that a segment including the known acoustic signal in the mixed acoustic signal is automatedly estimated, based on the amplitude spectrum of the mixed acoustic signal, and the correction step, removal step, inverse transforming step, and synthesis step are executed on this segment. When the known acoustic signal is included comparatively clearly in the mixed acoustic signal (e.g. when there is a segment in which the known acoustic signal sounds solely in the mixed acoustic signal), the segment can be identified by the automated estimation. Then, by using the automated estimation, the removal operation of the known acoustic signal can be quickly performed. Incidentally, when the existence of the known acoustic signal included in the mixed acoustic signal is not so clear, manual specification of the segment is performed.

Further, in the known acoustic signal removal method of the present invention, when a plurality of kinds of known acoustic signals exist corresponding to those included in the mixed acoustic signal, the known acoustic signal transforming step and the correction step are executed on all of the known acoustic signals. Then, using the amplitude spectrum after removal, resulting from the execution of the removal step of removing all the corrected amplitude spectra of the plurality of the known acoustic signals from the amplitude spectra of the mixed acoustic signal, the inverse transforming step and the synthesis step are executed. With this arrangement, all the known acoustic signals can be removed from the mixed acoustic signal.

When the correction step is executed, a graphic user interface (GUI) for performing interface processing is employed. In the interface processing, at least one of the corrections of the positional change in time, the temporal change in the frequency characteristic, the temporal change in the volume, the expansion or the contraction in the time axis direction, and the expansion or the contraction in the frequency axis direction can be manually specified.

A module for performing the interface processing is so configured that the accurate position of the known acoustic signal in the mixed acoustic signal can be manually specified when the known acoustic signal component is removed from the mixed acoustic signal having a plurality of acoustic signals mixed therein.

The module for performing the interface processing is so configured that the temporal changes in the frequency characteristic of the known acoustic signal in the mixed acoustic signal can be manually specified when those changes occur. Further, the module for performing the interface processing is so configured that temporal changes in the volume of the known acoustic signal in the mixed acoustic signal can be manually specified when those changes occur.

Further, the module for performing the interface processing is so configured that the expansions or contractions in the time axis or the frequency axis direction of the known acoustic signal in the mixed acoustic signal can be manually specified when those expansions or contractions occur.

In addition, the module for performing the interface processing is so configured that the corresponding segments of the mixed acoustic signal and the known acoustic signal can be manually specified.

A known acoustic signal removal device according to the present invention is constituted by: mixed acoustic signal transforming means for transforming a mixed acoustic signal into a time-frequency representation, thereby obtaining the amplitude spectrum of the mixed acoustic signal and the phase of the mixed acoustic signal; known acoustic signal transforming means for transforming a known acoustic signal corresponding to the mixed known acoustic signal included in the mixed acoustic signal into a time-frequency representation, thereby obtaining the amplitude spectrum of the known acoustic signal; correction means for obtaining the corrected amplitude spectrum of the known acoustic signal by correcting at least one of a positional shift over time, a temporal change in the frequency characteristic, a temporal change in the volume, an expansion or a contraction in the time axis direction, and an expansion or a contraction in the frequency axis direction of the amplitude spectrum of the known acoustic signal in relation to the amplitude spectrum of the mixed acoustic signal, based on the amplitude spectrum of the mixed acoustic signal; removal means for removing the corrected amplitude spectrum of the known acoustic signal from the amplitude spectrum of the mixed acoustic signal; inverse transforming means for performing an inverse transform into a time representation based on the amplitude spectrum after removal obtained by the removal means and the phase of the mixed acoustic signal, thereby obtaining unit waveforms; and synthesis means for synthesizing the unit waveforms, thereby obtaining an acoustic signal from which the known acoustic signal component has been removed.

The correction means herein includes a module for performing interface processing for allowing manual specification of at least one of the corrections of the positional shift over time, the temporal change in the frequency characteristic, the temporal change in the volume, the expansion or the contraction in the time axis direction, and the expansion or the contraction in the frequency axis direction of the amplitude spectrum of the known acoustic signal in relation to the amplitude spectrum of the mixed acoustic signal.

The module for performing the interface processing includes an image display section and an acoustic reproducing section. The image display section displays image so that the amplitude spectrum of the known acoustic signal can be visually contrasted with that of the known acoustic signal. The acoustic reproducing section reproduces as sounds the mixed acoustic signal, the known acoustic signal, and the output signal of the synthesis means.

When the module for performing the interface processing is employed, based on the amplitude spectrum of the mixed acoustic signal and the amplitude spectrum of the known acoustic signal displayed on the image display section, and/or the reproduced sounds from the acoustic reproducing section, not only the segment of the known acoustic signal included in the mixed acoustic signal can be manually specified, but also at least one of the corrections of the positional shift over time, the temporal change in the frequency characteristic, the temporal change in the volume, the expansion or the contraction in the time axis direction, and the expansion or the contraction in the frequency axis direction of the amplitude spectrum of the known acoustic signal in this section can be manually specified. As a result, even if the state of the known acoustic signal included in the mixed acoustic signal is more or less complex, the known acoustic signal can be removed with high accuracy.

Incidentally, it is preferable that the image display section is so constructed as to display the amplitude spectrum of the mixed acoustic signal in a segment including the known acoustic signal and the corrected amplitude spectrum, being aligned with each other on a time axis. The corrected amplitude spectrum has been obtained by correcting at least one of the positional shift over time, the temporal change in the frequency characteristic, the temporal change in the volume, the expansion or the contraction in the time axis direction, and the expansion or the contraction in the frequency axis direction of the amplitude spectrum of the known acoustic signal in the corresponding segment.

With this arrangement, the state of the corrected amplitude spectrum can be visually recognized. Thus, while viewing an image, manual estimation is possible on what kind of corrected spectrum can enhance the accuracy of removal, which speeds up removal operation.

Further, it is preferable that the image display section is so constructed as to allow image display of the amplitude spectrum of the acoustic signal obtained by removing the corrected amplitude spectrum from the amplitude spectrum of the mixed acoustic signal. With this arrangement, the effect of the correction can be visually confirmed from the displayed image. Thus, e the known acoustic signal can be removed from the mixed acoustic signal to the maximum, while performing the correction by a cut-and-try method.

A known acoustic signal removal program of the present invention is so configured as to cause a computer to execute steps including: a mixed acoustic signal transforming step of transforming a mixed acoustic signal into a time-frequency representation, thereby obtaining the amplitude spectrum of the mixed acoustic signal and the phase of the mixed acoustic signal; a known acoustic signal transforming step of transforming a known acoustic signal corresponding to the mixed known acoustic signal included in the mixed acoustic signal into a time-frequency representation, thereby obtaining the amplitude spectrum of the known acoustic signal; a correction step of obtaining the corrected amplitude spectrum of the known acoustic signal by correcting at least one of a positional shift over time, a temporal change in the frequency characteristic, a temporal change in the volume, an expansion or a contraction in the time axis direction, and an expansion or a contraction in the frequency axis direction of the amplitude spectrum of the known acoustic signal in relation respect to the amplitude spectrum of the mixed acoustic signal, based on the amplitude spectrum of the mixed acoustic signal; a removal step of removing the corrected amplitude spectrum of the known acoustic signal from the amplitude spectrum of the mixed acoustic signal; and an inverse transforming step of performing an inverse transform into a time representation based on the amplitude spectrum after removal obtained by the removal step and the phase of the mixed acoustic signal, thereby obtaining unit waveforms; and a synthesis step of synthesizing the unit waveforms, thereby obtaining an acoustic signal from which the component of the known acoustic signal has been removed.

According to the known acoustic signal removal method of the present invention, the corrected amplitude spectrum of the known acoustic signal is obtained in the correction step by correcting at least one of the positional shift over time, the temporal change in the frequency characteristic, the temporal change in the volume, the expansion or the contraction in the time axis direction, and the expansion or the contraction in the frequency axis direction of the amplitude spectrum of the known acoustic signal in relation to the amplitude spectrum of the mixed acoustic signal. This corrected amplitude spectrum is removed from the amplitude spectrum of the mixed acoustic signal. Thus, as an advantage obtained therefrom, the known acoustic signal included in the mixed acoustic signal as nonstationary noise can be removed with high accuracy.

Further, according to the known acoustic signal removal method of the present invention, when the acoustic signal of a TV program, a movie, or the like having a BGM played in the background of a human voice or a sound therein is input, it becomes possible to remove the BGM in the program using the acoustic signal of the music of the BGM prepared separately, and the acoustic signal constituted by the human voice or the sound alone can be obtained. Further, by providing the acoustic signal after removal of the BGM with another music as a BGM, the TV program, movie, or the like can be used again with a replaced music.

Since the known acoustic signal may be an arbitrary acoustic signal, the invention can be applied irrespective of the category of music, and irrespective of the presence or absence of a vocalist and/or musical accompaniment. The application is not limited to music. The present invention can be applied to an arbitrary known noise including stationary and nonstationary noises.

Further, by manual modification using the interface for a user in the known acoustic signal removal device, a higher-quality removal operation can be implemented at an actual job site.

### BRIEF DESCRIPTION OF THE DRAWINGS

FIG. 1 is a block diagram showing a configuration of a known acoustic signal removal device according to an embodiment of the present invention.

FIG. 2 is a block diagram showing steps when a known acoustic signal removal method of the present invention is carried out.

FIG. 3 is a flowchart showing an example of an algorithm of a program used when the main portion of the known acoustic signal removal device of the present invention is implemented using a computer.

FIG. 4 is a flowchart showing details at step ST103 in FIG. 3.

FIG. 5 is a flowchart showing details of steps to be performed when estimating operations either manually or automatedly.

FIG. 6 is a diagram showing an interface screen configuration of an editor.

FIG. 7 is a graph showing a temporal change in the power of a mixed acoustic signal.

FIG. 8 is a graph showing a temporal change in the amplitude spectrum of the mixed acoustic signal.

FIG. 9 is a graph showing a temporal change in the power of a known acoustic signal from the original sound source of a BGM.

FIG. 10 is a graph showing a temporal change in the amplitude spectrum of the known acoustic signal from the original sound source of a BGM.

FIG. 11 is a graph showing a temporal change in the power of a desired acoustic signal after removal of a mixed known acoustic signal.

FIG. 12 is a graph showing a temporal change in the amplitude spectrum of the desired acoustic signal after the removal of the mixed known acoustic signal.

### BEST MODE FOR CARRYING OUT THE INVENTION

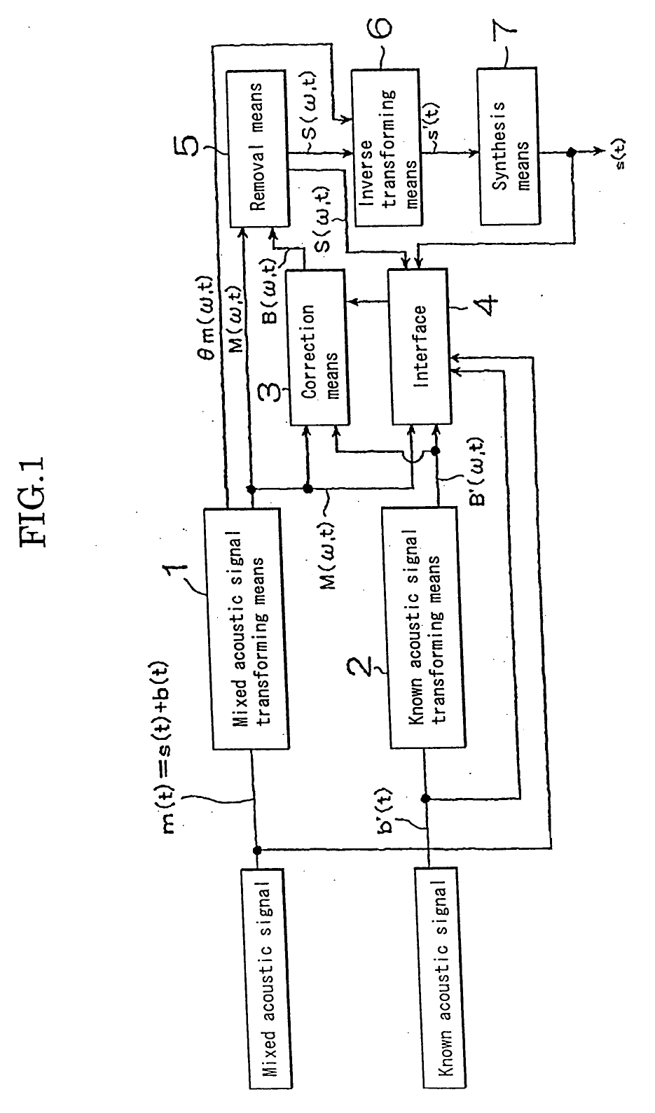

An example of an embodiment of the present invention will be described in detail with reference to drawings as follows. FIG. 1 is a block diagram showing a configuration of a known acoustic signal removal device according to the embodiment of the present invention for carrying out a known acoustic signal removal method of the present invention.

The known acoustic signal removal device has a system configuration constituted by mixed acoustic signal transforming means 1, known acoustic signal transforming means 2, correction means 3, an interface 4, removal means 5, inverse transforming means 6, and synthesis means 7.

The mixed acoustic signal transforming means 1 transforms a mixed acoustic signal m(t) in which an acoustic signal s(t) (where t indicates a time axis) of a desired voice, a sound, and the like are mixed with an acoustic signal b(t) of a BGM or the like (at this point, the signal s(t) and the signal b(t) being unknown, and only the signal m(t) being input) into a time-frequency representation, thereby obtaining an amplitude spectrum M (ω,t) of the mixed acoustic signal and a phase θm (ω,t) of the mixed acoustic signal.

The known acoustic signal transforming means 2 transforms a known acoustic signal b′(t) of the original sound source, to which the acoustic signal b(t) to be removed corresponds, into a time-frequency representation, thereby obtaining an amplitude spectrum B′(ω,t) of the known acoustic signal.

Then, the correction means 3 obtains a corrected amplitude spectrum B (ω,t) of the known acoustic signal, the corrected amplitude spectrum B(ω,t) being obtained by correcting a positional shift over time, a temporal change in the frequency characteristic, a temporal change in the volume, and expansions or contractions in the time axis and in the frequency axis directions of the amplitude spectrum B′(ω,t) of the known acoustic signal in relation to the amplitude spectrum M (ω,t) of the mixed acoustic signal, based on the amplitude spectrum M (ω,t) of the mixed acoustic signal. For automation, the correction means 3 can be so configured that all of the positional shift over time, the temporal change in the frequency characteristic, the temporal change in the volume, and the expansions or contractions in the time axis and the frequency axis directions are automatedly estimated and corrected.

In this embodiment, the correction means 3 is so configured that all of the corrections such as the positional shift over time, the temporal change in the frequency characteristic, the temporal change in the volume, and the expansions or contractions in the time and the frequency axis directions can be manually specified, using the interface 4.

As described in detail later, this interface 4 is equipped with an image display section that displays an image so that the amplitude spectrum of the mixed acoustic signal can be visually contrasted with the amplitude spectrum of the known acoustic signal. The interface 4 is a module that performs interface processing through a graphic user interface (GUI).

The interface 4 is so configured that the segment of the mixed known acoustic signal included in the mixed acoustic signal, as well as the corrections described above, can be manually specified, based on the amplitude spectrum of the mixed acoustic signal and that of the known acoustic signal, through an input section displayed on the screen thereof. The removal means 5 removes the corrected amplitude spectrum B(ω,t) of the known acoustic signal from the amplitude spectrum M(ω,t) of the mixed acoustic signal. The inverse transforming means 6 performs an inverse transform into a time representation based on an amplitude spectrum after removal S(ω,t) obtained from the removal means 5 and a phase θm(ω,t) of the mixed acoustic signal, thereby obtaining unit waveforms s′(t).

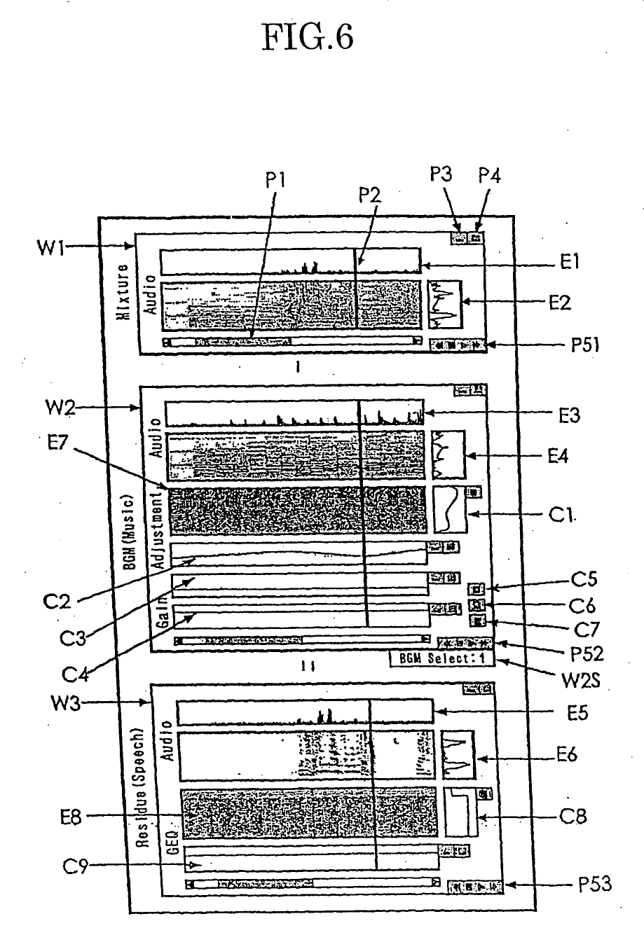

Finally, the synthesis means 7 performs synthesis of the unit waveforms s′(t) output from the inverse transforming means 6, thereby obtaining the acoustic signal s(t) from which a known acoustic signal component has been removed. The interface 4 displays the amplitude spectrum after removal S(ω,t) output from the removal means 5 on an image display section (refer to FIG. 6). The interface 4 includes an acoustic reproducing section, and reproduces the mixed acoustic signal, the known acoustic signal, and the synthesized acoustic signal output from the synthesis means 7.

In this configuration, the effect of the corrections can be visually confirmed through the image display section. Further, the effect of the corrections can also be aurally confirmed through the acoustic reproducing section included therein. Thus, the maximum removal of the mixed known acoustic signal from the mixed acoustic signal is possible by manually specifying necessary corrections while using a cut-and-try method, and viewing the screen display of the image display section of the interface 4.

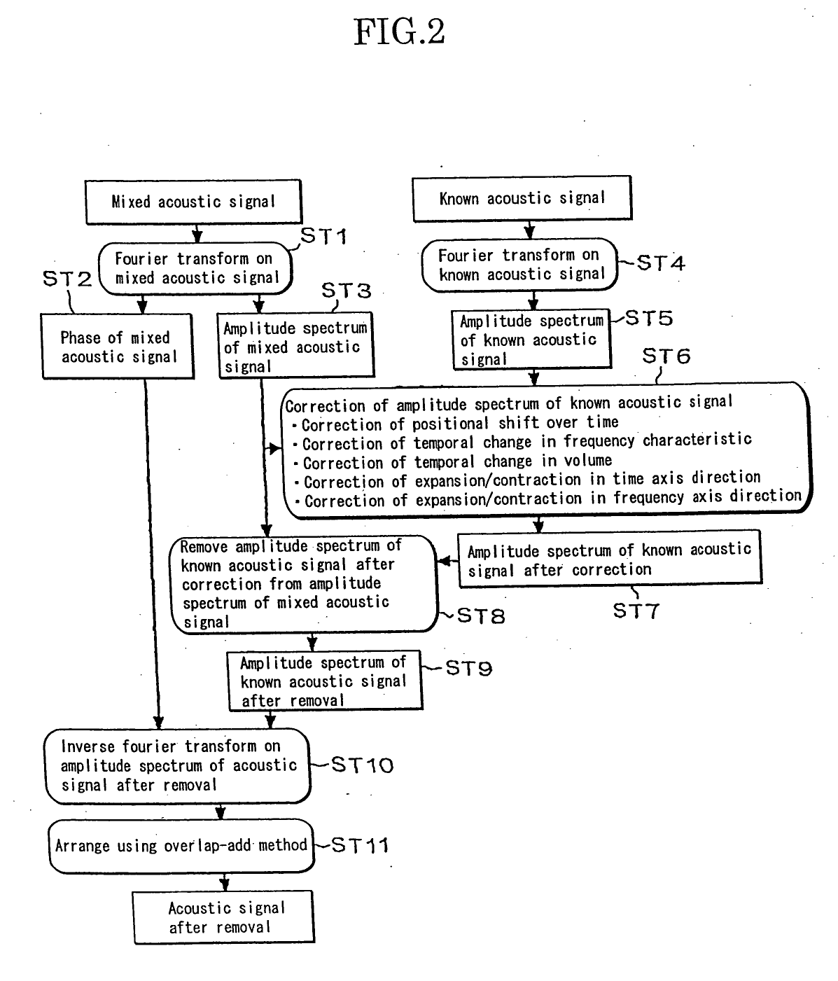

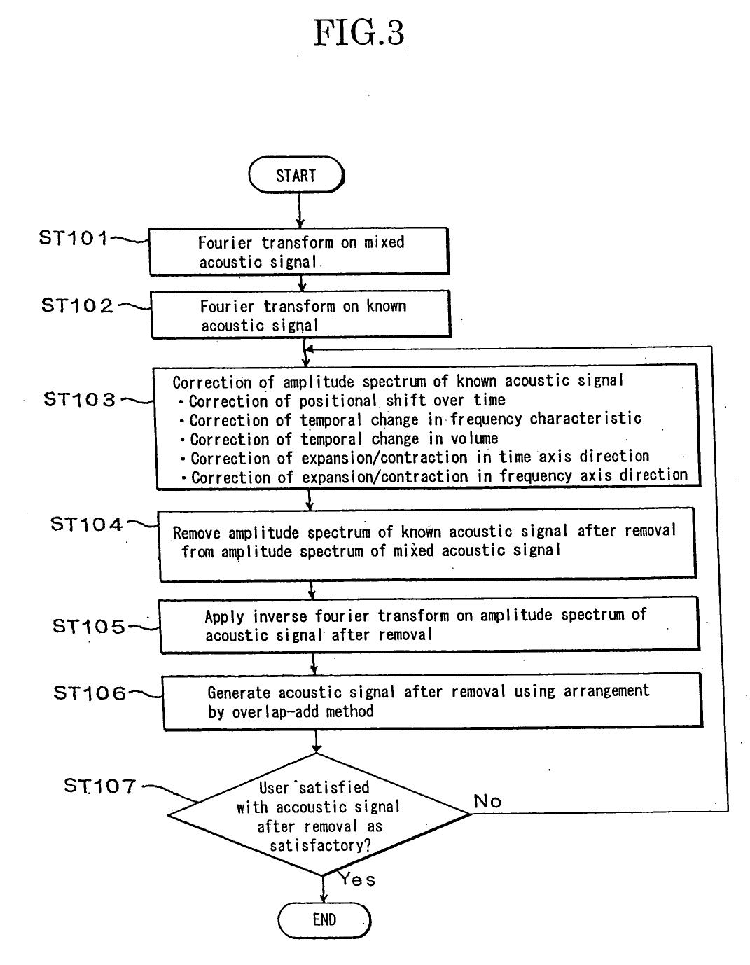

Next, using FIGS. 2 and 3, an example of the embodiment of the known acoustic signal removal device of the present invention is described in detail. FIG. 2 is a block diagram showing steps when the known acoustic signal removal method of the present invention is carried out. FIG. 3 is a flowchart showing an example of an algorithm of a program when the main portion of the known acoustic signal removal device of the present invention is implemented by a computer.

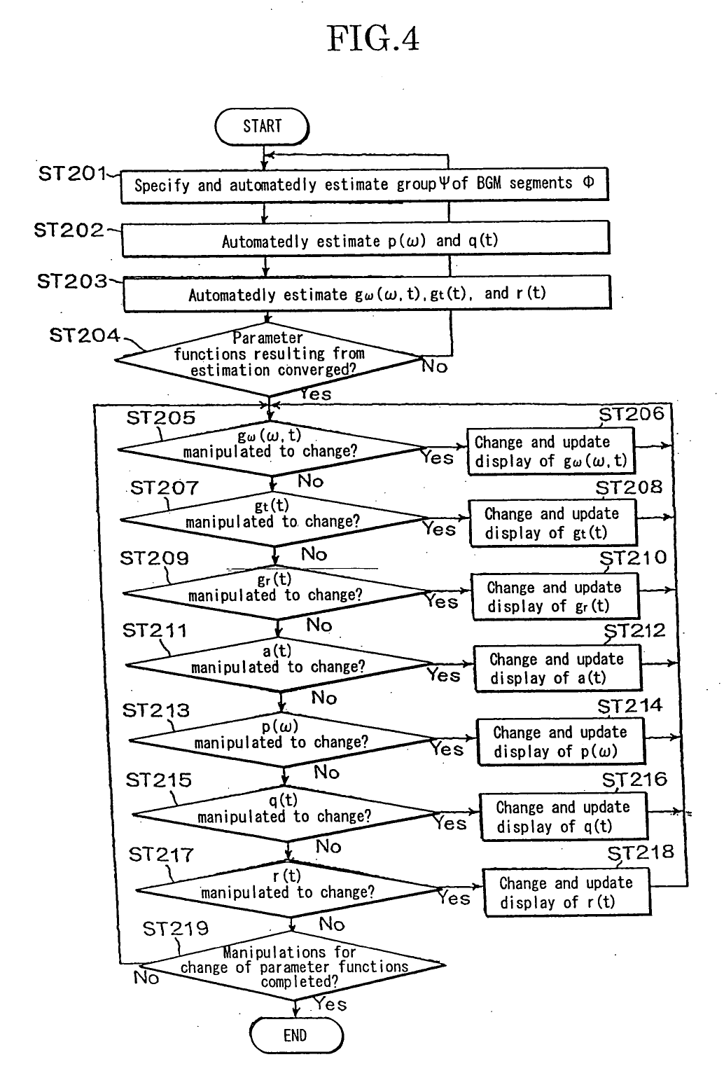

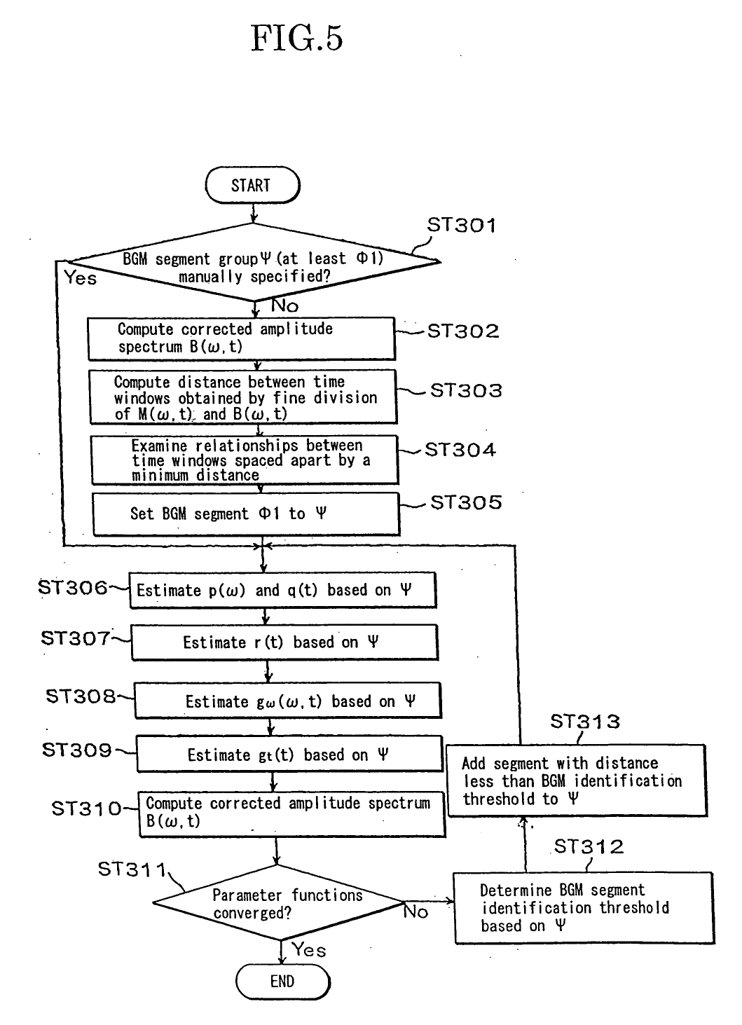

FIG. 4 is a flowchart showing details in step ST103 in FIG. 3. FIG. 5 is a flowchart showing details of steps when estimation is executed both manually and automatedly. The known acoustic signal removal method and an operation of the known acoustic signal removal by the known acoustic signal removal device according to the present invention are described below with reference to FIGS. 1 through 5.

First, in the following description, it is assumed that the mixed acoustic signal m(t) is observed. In the mixed acoustic signal m(t), the acoustic signal s(t) (in which t indicates the time axis) of the desired voice, sound, and the like are mixed with the acoustic signal b(t) of the BGM(back ground music), or the like, which is the mixed known acoustic signal to be removed.
m(t)=s(t)+b(t) (1)
Herein, the problem of obtaining the unknown signal s(t) is acquired when the signal m(t) is given under a condition that the acoustic signal b′(t), which is the acoustic signal from an original sound source to which the signal b(t) corresponds, is known. Assume that the acoustic signal m(t) of a TV program and etc. including a human voice, a sound, and the BGM played therein is input, and that the music of the BGM is known, and its acoustic signal b′(t) can be prepared separately, for example. Then, using the acoustic signal of the music in the BGM, the BGM in the program is removed and the acoustic signal s(t) of the human voice and the sound alone is obtained. Since the signal b(t) and the signal b′(t) do not coincide with each other completely, a component corresponding to the signal b(t) needs to be estimated from the signal b′(t) to obtain the signal s(t) in the process corresponding to the following subtraction:
s(t)=m(t)−b(t) (2)
Specifically, in the mixed sound m(t), the known acoustic signal b′(t) often involves deformations which will be described below. Thus, by making corrections, the component corresponding to the signal b(t) is estimated. Targets for the corrections are mainly the positional shift over time, the temporal change in the frequency characteristic, the temporal change in the volume, and the expansion or contraction in the time axis or frequency axis direction, all of which will be described below.
(Positional Shift Over Time)

The known acoustic signal b′(t) does not always sound from the beginning position thereof in the mixed sound m(t). Thus, it is necessary to shift the known acoustic signal b′(t) in the time axis direction so as to align the relative positions of the both signals and then to subtract the mixed known acoustic signal from the mixed sound signal.

(Temporal Change in Frequency Characteristic)

When the known acoustic signal b′(t) sounds in the mixed sounds m(t), the frequency characteristic often changes due to the influence of a graphic equalizer or the like. Low-frequency or high-frequency emphasis and/or attenuation, for example, sometimes occur. Thus, it is necessary to change and correct the frequency characteristic of the b′(t) correspondingly, and then subtract the known acoustic signal from the mixed sound signal.

(Temporal Change in Volume)

When the mixed known acoustic signal b′(t) sounds in the mixed sound m(t), it often happens that the ratio of the mixing is changed by the operation of the fader of a mixer at the time of mixed sound creation and the sound volume changes temporally. Thus, it is necessary to temporally change and correct the volume of the acoustic signal b′(t) correspondingly, and then subtract the mixed known acoustic signal from the mixed sound signal.

(Expansion/Contraction in Time Axis or Frequency Axis Direction)

When the mixed known acoustic signal b′(t) sounds in the mixed sound m(t), an expansion or a contraction in the time axis direction or in the frequency axis direction may occur due to a difference of the revolution of a record or the like. Thus, it is necessary to expand or contract b′(t) in the time axis direction or in the frequency axis direction, for correction, and then subtract the mixed known acoustic signal from the mixed sound signal.

In the known acoustic signal removal method of the present invention, as the first step, the mixed acoustic signal is subject to a Fourier transform at step ST1, as shown in FIG. 2. Then, the phase of the mixed acoustic signal is obtained (at step ST2), and the amplitude spectrum of the mixed acoustic signal is obtained (at step ST3) (mixed acoustic signal transforming step). In addition, the known acoustic signal corresponding to the acoustic signal included in the mixed acoustic signal is subject to the Fourier transform at step ST4, thereby obtaining the amplitude spectrum of the known acoustic signal (at step ST5) (known acoustic signal transforming step). Then, at step 6, at least one of the positional shift over time, temporal change in the frequency characteristic, temporal change in the volume, and the expansion or contraction in the time axis direction, and the expansion or contraction in the frequency axis direction of the amplitude spectrum of the known acoustic signal is corrected in relation to the amplitude spectrum of the mixed acoustic signal, based on the amplitude spectrum of the mixed acoustic signal, to obtain the corrected amplitude spectrum of the known acoustic signal (at step ST7) (correction step). Next, the corrected amplitude spectrum of the known acoustic signal is removed from the amplitude spectrum of the mixed acoustic signal at step ST8, thereby obtaining the amplitude spectrum after removal (at step ST9) (removal step) At next step ST10, an inverse Fourier transform is performed, based on the amplitude spectrum after removal obtained by the removal step and the phase of the mixed acoustic signal, thereby obtaining unit waveforms (inverse transforming step). Finally, at step ST11, the unit waveforms are synthesized using an overlap-add method, thereby obtaining the acoustic signal from which the known acoustic signal component has been removed (synthesis step).

In the algorithm of the program used when these processing is implemented by the computer, as shown in the flowchart in FIG. 3, the mixed acoustic signal is first subject to the Fourier transform at step ST101, thereby obtaining the amplitude spectrum of the mixed acoustic signal and the phase of the mixed acoustic signal. Next, at step ST102, the known acoustic signal corresponding to the acoustic signal included in the mixed acoustic signal is subject to the Fourier transform, thereby obtaining the amplitude spectrum of the known acoustic signal.

At next step ST103, the corrected amplitude spectrum of the known acoustic signal is obtained by correcting at least one of the positional shift over time, the temporal change in the frequency characteristic, the temporal change in the volume, and the expansion or contraction in the time axis direction, and the expansion or contraction in the frequency direction of the amplitude spectrum of the known acoustic signal in relation to the amplitude spectrum of the mixed acoustic signal based on the amplitude spectrum of the mixed acoustic signal.

Then, at step ST104, the corrected amplitude spectrum of the known acoustic signal is removed from the amplitude spectrum of the mixed acoustic signal, thereby obtaining the amplitude spectrum after removal.

Next, at step ST105, the inverse Fourier transform is performed based on the amplitude spectrum after removal obtained at step ST104 and the phase of the mixed acoustic signal, thereby obtaining the unit waveforms. At step ST 106, the unit waveforms are synthesized by the overlap-add method, thereby obtaining the acoustic signal from which the known acoustic signal component has been removed.

Then, at step ST107, a determination is added as to whether the user has found the acoustic signal obtained after the removal satisfactory or not. When the result of determination is unsatisfactory, the operation returns to step ST103, and the corrections are performed again. Until the user gets satisfied with the acoustic signal, processing from step ST103 to step ST107 is repeated.

Contents executed at each step will be further described below in detail. In the method according to the embodiment of the present invention, subtraction of a waveform is not performed in a time domain. The subtraction is performed on the amplitude spectrum in a time-frequency domain.

When Xₘ(ω,t) and X_{b}′(ω,t) that have been subject to a short-time Fourier transform (STFT) using a window function h(t) at a time t in relation to the acoustic signals m(t) and b′(t) are defined as;

$$\begin{matrix}{X}_{m} ( ω , t ) = {\int }_{- ∞}^{∞} m ( τ ) h ( τ - t ) {ⅇ}^{- jωτ} ⅆ τ & ( 3 ) \\ = {α}_{m} ( ω , t ) + j {β}_{m} ( ω , t ) & ( 4 ) \\ {X}_{{b}^{′}} ( ω , t ) = {\int }_{- ∞}^{∞} {b}^{′} ( τ ) h ( τ - t ) {ⅇ}^{- jωτ} ⅆ τ & ( 5 ) \\ = {α}_{{b}^{′}} ( ω , t ) + j {β}_{{b}^{′}} ( ω , t ) & ( 6 )\end{matrix}$$

the amplitude spectra M(ω,t) and B′(ω,t) of these are obtained by the followings:

$$\begin{matrix}M ( ω , t ) = \vert {X}_{m} ( ω , t ) \vert & ( 7 ) \\ = \sqrt{{α}_{m}^{2} ( ω , t ) + {β}_{m}^{2} ( ω , t )} & ( 8 ) \\ {B}^{′} ( ω , t ) = \vert {X}_{{b}^{′}} ( ω , t ) \vert & ( 9 ) \\ = \sqrt{{α}_{{b}^{′}}^{2} ( ω , t ) + {β}_{{b}^{′}}^{2} ( ω , t )} & ( 10 )\end{matrix}$$

In a current implementation, the acoustic signals are subject to A/D conversion at a sampling frequency of 44. 1 KHz and with the number of quantization bits of 16 bits, and the short-time Fourier transform (STFT) using a Hanning window with a window width of 8192 points as a window function h(t) is computed using a fast Fourier transform (FFT). In that occasion, each of the frames for the fast Fourier transform (FFT) is shifted by 441 points, so that a frame shift time (one frame shift) is 10 ms. This frame shift is determined as a processing time unit.

The amplitude spectrum S(ωo,t) of the desired acoustic signal s(t) after removal of the known acoustic signal is obtained from the spectra M(ω,t) and B′(ω,t) by the following equations, where the spectrum B(ω,t) is the amplitude spectrum obtained after the correction of the spectrum B′(ω,t).

$$\begin{matrix}S ( ω , t ) = \{ \begin{matrix}c ( ω , t ) ( M ( ω , t ) - B ( ω , t ) ) & if M ( ω , t ) > B ( ω , t ) \\ 0 & otherwise\end{matrix} & ( 11 ) \\ B ( ω , t ) = a ( t ) g ( ω , t ) {B}^{′} ( p ( ω ) , q ( t ) + r ( t ) ) & ( 12 )\end{matrix}$$

Various parameter functions a(t), g(ω,t), p(ω), q(t), r(t), and c(ω,t) in the above equations will be sequentially described.

The function a(t) herein is the function with an arbitrary shape, for finally adjusting the amount of subtraction of the component corresponding to the amplitude spectrum of the known acoustic signal from the amplitude spectrum of the mixed sound, and is normally set to be equal to or larger than one (a(t)≧1). The larger it is, the more the amount of subtraction becomes.

The function g(ω,t) is the function for correcting the temporal change in the frequency characteristic and the temporary change in the volume, and is defined as follows:
g(ω,t)=g_{ω}(ω,t)gₜ(t)+gᵣ(t) (13)
Here, g_{ω}(ω,t) indicates the temporal change in the frequency characteristic. When there is no change in the frequency characteristic, the function g_{ω}(ω,t) is one(g_{ω}(ω,t)=1). On the other hand, gₜ(t) indicates the temporal change in the volume. When there is no change in the volume, the function gₜ(t) is constant. A volume difference between the spectrum M(ω,t) and the spectrum B′(ω,t) is basically corrected by the function gₜ(t). The function gᵣ(t) is primarily used for increasing the value of the function g(ω,t) as a whole, and is used for a slight adjustment at the time of the corrections. When not used, the function gᵣ(t) is set to zero (gᵣ(t)=0).

The function p(ω) is the function for correcting the expansion or contraction in the frequency axis direction. By converting a frequency axis ω of the amplitude spectrum B′(ω,t), linear and nonlinear expansion or contraction in the frequency axis direction can be made. Incidentally, the spectrum B′(ω,t) is zero outside the original definition area of ω, and is interpolated properly when discretization is performed for implementation.

The function q(t) is the function for correcting the expansion or contraction in the time axis direction. By converting the time axis t of the amplitude spectrum B′(ω, t), linear and nonlinear expansions or contractions in the time axis direction can be made. Incidentally, the spectrum B′(ω,t) is zero outside the original definition area of t, and is interpolated properly when the discretization is performed for implementation.

The function r(t) is the function for correcting the positional shift over time. A constant is normally set for the function r(t), thereby correcting a certain width of the shift. When the width of the shift is changed over time, a function for correcting the width at each time is set. Incidentally, the spectrum B′(ω,t) is zero outside the original definition area of t, and is interpolated properly when the discretization is performed, for implementation. Though the functions q(t) and r(t) can be expressed as an integrated one function, the function q(t) is herein set in order to indicate a continuous expansion or contraction, while the function r(t) is set in order to indicate a discontinuous positional shift.

The function c(ω,t) is the function with an arbitrary shape for equalizing and for a fader operation on the amplitude spectrum. Depending on the shape in the direction of ω, the frequency characteristic after removal of the mixed known acoustic signal can be adjusted, as with a graphic equalizer. Further, depending on the shape in the direction of the time t, the change in the volume after removal of the mixed known acoustic signal can be adjusted, as in the operation of the volume fader of a mixer. When not in use, the function c(ω,t) is set to one(c(ω,t)=1).

Using the amplitude spectrum S(ω,t) obtained as described above and a phase θₘ(ω,t) of the mixed sound m(t), a signal Xₛ(ω,t) is obtained, and performing the inverse Fourier transform (IFFT) on this, unit waveforms s′(t) are obtained.

$$\begin{matrix}{θ}_{m} ( ω , t ) = arctan ( \frac{{β}_{m} ( ω , t )}{{α}_{m} ( ω , t )} ) & ( 14 ) \\ {X}_{s} ( ω , t ) = S ( ω , t ) {ⅇ}^{{jθ}_{m} ( ω , t )} & ( 15 ) \\ {s}^{′} ( t ) = \frac{h ( t )}{2 π} {\int }_{- ∞}^{∞} {X}_{s} ( ω , t ) {ⅇ}^{jω t} ⅆ ω & ( 16 )\end{matrix}$$

By arranging the unit waveforms s′(t) by the overlap-add (Overlap Add) method, the desired acoustic signal s(t) after removal of the mixed known acoustic signal is synthesized. The above describes a case where one type of the known acoustic signal b′(t) is included in the mixed acoustic signal m(t). When a plurality of known acoustic signals such as b′₁(t), b′₂(t) . . . , and b′_{N}(t) are included, using spectra B₁(ω,t), B₂(ω,t), . . . , and B_{N}(ω,t) obtained respectively from amplitude spectra B′₁(ω,t), B′₂(ω,t), . . . B′_{N}(ω,t) using Equation (12) by setting a parameter function corresponding to each thereof, the processing can be extended for obtaining S(ω,t) as follows:

$$S ( ω , t ) = \{ \begin{matrix}c ( ω , t ) ( M ( ω , t ) - {\sum }_{n = 1}^{N} {B}_{n} ( ω , t ) ) & if M ( ω , t ) > {\sum }_{n = 1}^{N} {B}_{n} ( ω , t ) \\ 0 & otherwise\end{matrix} \qquad ( 17 )$$

In this occasion, various parameter functions for the spectrum Bₙ(ω,t) are sequentially set, or various parameter functions for the spectrum Bₙ(ω,t) are set in parallel while maintaining overall balance.

Though the above description describes a monaural signal, the invention may be applied to a stereo signal. The stereo signal may be applied after a left stereo signal and a right stereo signal are mixed and converted into a monaural signal. Alternatively, the present invention may be applied to each of the left stereo signal and the right stereo signal. The stereo signal may be applied, using the sound source direction in a stereo signal.

Setting of the above-mentioned various parameter functions are described as follows. When the method of the present invention is applied, the shapes of the various parameter functions a(t), g(ω,t), (g_{ω}(ω,t) , gₜ(t), gᵣ(t)) p(ω), q(t), r(t), c(ω,t) may be automatedly estimated, or may be manually set. Alternatively, after the automated estimation, manual modification may be made. A specific automated estimation method will be described below, together with a case where the interface 4 is used in the known acoustic signal removing device, thereby allowing manual modification.

First, the method of estimating the shapes of the various parameter functions g(ω,t), (g_{ω}(ω,t), gₜ(t)), p(ω), q(t), r(t) in Equations (11), (12), and (13) will be described below, using FIG. 4. First, at step ST201, specification and automated estimation of a group Ψ of BGM segments ψ are performed. At step ST202, automated estimation of the functions p(ω) and q(t) is performed. At step ST203, automated estimation of the functions g_{ω}(ω,t), gₜ(t), and r(t) is performed. Then, until the parameter functions resulting from the estimations have converged, these steps are continued (at step ST204). At step ST205 and thereafter, correcting operations are executed using the interface 4.

In the estimation of the function g(ω,t), the function g_{ω}(ω,t) indicating the temporal frequency characteristic change is estimated first. Next, the function gₜ(t) indicating the temporal volume change is estimated. Before the function g(ω,t) is estimated, however, it is necessary that the functions p(ω), q(t), and r(t) have been determined. Here, for convenience, a spectrum B′(p(ω), q(t)+r(t)) is described as the spectrum B′(ω,t).

For the estimation of the function g_{ω}(ω,t) indicating the temporal change of the frequency characteristic, a segment in which the acoustic signal s(t) of the human voice and sound alone is scarcely included (hereinafter referred to as a BGM segment) is employed. A plurality of BGM segments may also be employed. In the BGM segment, the amplitude spectrum M(ω,t) of the mixed sound m(t) is mainly constituted by a component derived from the amplitude spectrum B′(ω,t) of the known acoustic signal b′(t) corresponding to the BGM. Then, when it can be assumed that the frequency characteristic is not changed over time and is constant, or when the function g_{ω}(ω,t) indicating the frequency characteristic temporal change can be assumed to be equal to a function g′_{ω}(ω), (g_{ω}(ω, t)=g′_{ω}(ω)), the function g′_{ω}(ω) is estimated from the following equation:

$${g}_{ω}^{′} ( ω ) = \frac{{\int }_{ψ ∈ Ψ} M ( ω , t ) ⅆ t}{{\int }_{ψ ∈ Ψ} {B}^{′} ( ω , t ) ⅆ t} \qquad ( 18 )$$

Here ψ indicates one BGM segment (a region on the time axis), and Ψ indicates a group of segments ψ. On the other hand, when the frequency characteristic is changed over time, from the BGM segment ψ at a time close to the time t of the function g_{ω}(ω,t), the following is obtained:

$$\frac{{\int }_{ψ} M ( ω , t ) ⅆ t}{{\int }_{ψ} {B}^{′} ( ω , t ) ⅆ t} \qquad ( 19 )$$

Then, by performing interpolation (interpolation or extrapolation), the function g_{ω}(ω,t) is estimated (when the BGM segments are present on both sides, the interpolation from the both sides is performed). Finally, the function g_{ω}(ω,t) is smoothed in the frequency axis direction. Incidentally, the width of smoothing can be arbitrarily set, or the smoothing may not need to be performed.

In the estimation of the function gₜ(t) indicating the temporal volume change, amplitude comparison at each time is performed between the amplitude spectrum M(ω,t) and a spectrum g_{ω}(ω,t) B′(ω,t) after correction of the frequency characteristic. However, in addition to the component the spectrum B′(ω,t), a component derived from corresponding to the acoustic signal s(t) is also included in the amplitude spectrum M(ω,t). Hence, the frequency axis ω is divided into a plurality of frequency bands Φ, and for each band φ(φεΦ), the following function is determined:

$${g}_{t}^{′} ( ϕ , t ) = \frac{{\int }_{ϕ} M ( ω , t ) ⅆ ω}{{\int }_{ϕ} {g}_{ω} ( ω , t ) {B}^{′} ( ω , t ) ⅆ ω} ( ϕ ∈ Φ ) \qquad ( 20 )$$

(Φ indicates a group of φ). Arbitrary division can be applied to obtain the bands Φ. The division may be, for example, performed for each octave in equal temperament used in music (division at equal intervals on a logarithmic frequency axis). Then, gₜ(t) is estimated from min(g′ₜ(φ, t)) or the following expression:

$$\frac{{\sum }_{ϕ ∈ Φ} {g}_{t}^{′} ( ϕ , t )}{{\sum }_{ϕ ∈ Φ} 1} \qquad ( 21 )$$

When min(g′ₜ(φ,t)) is employed, the amplitude comparison is performed in a frequency band where M(ω, t) and gω(ω,t) B′(ω,t) is closest. Finally, gₜ(t) is smoothed in the frequency axis direction. Incidentally, the width of the smoothing can be arbitrarily set. The smoothing may not need to be performed.

In the estimations of the functions p(ω) and q(t), the functions p(ω) and q(t) are changed so that a distance between the spectrum M(ω,t) and the spectrum B(ω,t) (such as a logarithmic spectrum distance or the like) is minimized. In this occasion, in the right side of an equation, B(ω,t)=a(t)g(ω,t)B′(p(ω),q(t)+r(t)), the function a(t) is set to one(a(t)=1), and the appropriate functions p(ω) and q(t) are estimated by recurrently repeating the following two estimations:
1. After the functions p(ω) and q(t) (in the course of the estimation) have been temporarily fixed, the functions g(ω, t) and r(t) are estimated; and
2. After the functions g(ω,t) and r(t) (in the course of the estimation) have been temporarily fixed, p(ω) and q(ω) are estimated.
   These operations may not be executed at one time the segments of the acoustic signals, but may be executed segmentally by dividing the time axis. Initial values are defined in view of continuity between the preceding and the following segments. Further, using the group Ψ of the BGM segments ψ, the functions p(ω) and q(t) are estimated so that the spectrum M(ω, t) may be aligned with the spectrum B(ω, t) on a time axis in relationships in those segments.

For the estimation of the function r(t), the group Ψ of the BGM segments ψ is fundamentally used, and the function r(t) is determined so that the spectrum M(ω,t) may be aligned with t the spectrum B(ω,t) on a time axis in relationships in those segments. The function r(t) is often a constant. However, when a part parts of the segments of the known acoustic signal b′(t) is not used or discontinuous segments in the known acoustic signal b′(t) are used in the mixed sound, the function r(t) becomes a discontinuous function so that the non-used segments are skipped.

In the estimation of the functions g(ω,t) and r(t) described above, the group Ψ of the BGM segments ψ is used. This group may be manually specified. Alternatively, an automated estimation may be added to the manually specified group of BGM segments. FIG. 5 is a flowchart showing the software algorithm of a program that supports both cases of manual specification and the automated estimation. When the automated estimation is performed, processing in steps ST302 to ST313 in FIG. 5 is executed. In the automated estimation of the group Ψ, basically, using one BGM segment ψ1 as a clue, the group of the remaining BGM segments is determined. First, the first segment ψ1 is manually specified, or determined by finely dividing the time axes of the acoustic signals and evaluating the relationships between the resulting short segments. When the manual specification is not performed, the spectrum B(ω,t) is tentatively computed (at step ST302).

Then, amplitude spectrum distances between time windows (corresponding to the degrees of similarity therebetween) obtained by finely dividing the spectrum M(ω,t) and the spectrum B(ω,t) are computed (at step ST303). Then, the relationships between the time windows spaced apart by the minimum distance are examined (at step ST304), and the segment determined by the examination result is set as the initial segment ψ1, thereby obtaining the initial group Ψ (at step ST305). Next, based on the group Ψ including the segment ψ1, the various parameter functions for the spectrum B(ω,t) are estimated (at steps ST306 through ST309), thereby computing the spectrum B(ω,t) (at step ST310). It is then checked whether the estimated values of the respective parameters have converged. When it is found that they have not converged, distances between the amplitude spectra M(ω,t) and B(ω,t) (corresponding to the degrees of similarity therebetween) in all the segments of the group Ψ are obtained. Then, a multiple of a constant of the maximum value (or average value) of the distances is set as a BGM segment identification threshold (at step ST312). Then, a segment with a distance equal to or less than the BGM segment identification threshold is detected, and added to the group Ψ (at step ST313). The maximal addition can be set. By repeating these estimations and additions, the group Ψ is updated, and the various parameter functions are appropriately determined. As the distance between the spectrum M(ω,t) and the spectrum B(ω,t), a logarithmic mean square spectrum distance as follows, for example, is effective:

$$\int {( log M ( ω , t ) - log B ( ω , t ) )}^{2} ⅆ ω \qquad ( 22 )$$

Next, adjustment of the various parameter functions by the interface on a known acoustic signal removal editor will be described.

The editor, which is the user interface of the known acoustic signal removal device for manually setting the shapes of all the parameter functions a(t), g(ω, t), (g_{ω}(ω,t), gₜ(t), gᵣ(t)), p(c), q(t), r(t), and c(ω,t) in Equations (11) to (13), will be described below. The user of the editor may draw arbitrary function shapes from the beginning for specification. Alternatively, the automated estimation may be first performed, and the results thereof may be modified.

A screen construction of the editor is shown in FIG. 6. This editor is roughly constructed by three sub-windows including a sub-window W1 for operating the mixed acoustic signal m(t), a sub-window W2 for operating the known acoustic signal b′(t), and a sub-window W3 for operating the desired acoustic signal s(t) after removal of the known acoustic signal. When a plurality of types of known acoustic signals b′(t) are present, the known acoustic signal b′(t) to be operated on the sub-window W2 can be switched by a selection switch W2S. Using this interface, processing from step ST205 to step ST219 shown in FIG. 4 is executed.

First, functions common to all of the sub-windows will be described. An operating range slider P1 indicates where the acoustic signal is currently displayed. A cursor P2 indicates the position of an object targeted for a current operation on the time axis. When an iconizing (folding) button P3 is pressed, the sub-window to which the button belongs is temporarily folded and reduced in size. By hiding the unused sub-windows except the one being operated, effective utilization of a small screen becomes possible. When a floating (magnifying) button P4 is pressed, the sub-window to which the button belongs is temporarily separated (floated) from a parent window, and further enlarged. Operation and edition are thereby facilitated. When only the floating (magnifying) button P4 is shown, by pressing the button the sub-window associated with the button is floated and newly appears.

The sub-window W1 displays a graph E1 indicating the power of the mixed acoustic signal m(t) and a graph E2 indicating its amplitude spectrum M(ω,t). The sub-window W2 displays a graph E3 indicating the power of the known acoustic signal b′(t) and a graph E4 indicating its amplitude spectrum B′(ω,t). The sub-window W3 displays a graph E5 indicating the power of the acoustic signal s(t) after removal of the known acoustic signal and a graph E6 indicating its amplitude spectrum S(ω,t). In the graphs indicating the respective spectrum (E2, E4, or E6), an amplitude is indicated by shading on a left side thereof (where a horizontal axis indicates the time axis, while a vertical axis indicates the frequency axis), and the amplitude at the position of the cursor is plotted on a right side thereof (where the horizontal axis indicates the power, while the vertical axis indicates the frequency axis).

On a reproduction control operation panel P51, a group of buttons capable of reproducing, stopping, fast forwarding, and quick returning the mixed acoustic signal are arranged so that it may be checked aurally. Through operations on the reproduction control operation panel P51, the interface 4 reproduces the mixed acoustic signal by an acoustic reproducing section included therein.

The sub-window W2 for operating the known acoustic signal b′(t) is the window, which becomes the center of the operations, and can freely set the shapes of all the parameter functions a(t), g(ω,t), (g_{ω}(ω,t), gₜ(t), gᵣ(t)), p(ω), q(t), and r(t) in Equations (12) and (13). A description will be directed to each of operation panels below.

1. Operation Panel C1 for Correcting Temporal Change in Frequency Characteristic (to the Right of Panel E7)

It is a panel (where the horizontal axis indicates the magnitude of the function, and the vertical axis indicates the frequency axis), for displaying and manipulating the function g_{ω}(ω,t). The function g_{ω}(ω, t) at the time t at the position of the cursor is plotted. The result of a setting operation (at step ST205 and/or step ST206) is instantly reflected on the display panel E7 of the function g(ω,t) The magnitude of the value of the function g(ω,t) is indicated by shading on the panel E7 (where the horizontal axis indicates the time axis, while the vertical axis indicates the frequency axis).

2. Operation Panel C2 for Correcting Temporal Change in Volume (Below Panel E7)

It is a panel for displaying and manipulating the function gₜ(t). The result of a setting operation (at step ST207 and/or step ST208) is instantly reflected on the display panel E7 of the function g(ω,t).

3. Operation Panel C3 for Wholly Increasing the Value of Function g(ω,t) (Below Panel E7)

It is a panel for displaying and manipulating the function gᵣ(t). The result of a setting operation (at step ST209 and/or step ST210) is instantly reflected on the display panel E7 of the function g(ω,t).

4. Operation Panel C4 for Finally Adjusting Amount of Subtracting Component Corresponding to Amplitude Spectrum of Known Acoustic Signal from Amplitude Spectrum of Mixed Sound

It is a panel for displaying and manipulating the function a(t). When this panel is operated, a change in the function a(t) (at step ST211 and/or step ST212) is instantly reflected on a display.

5. Operation Panel C5 for Correcting Expansion or Contraction in Frequency Axis Direction

It is a panel for displaying and manipulating the function p(ω). When this panel is operated, a change in the function p(t) (at step ST213 and/or step ST214) is instantly reflected on a display.

6. Operation Panel C6 for Correcting Expansion or Contraction in Time Axis Direction

It is a panel for displaying and manipulating the function q(t). When this panel is operated, a change in the function q(t) (at step ST215 and/or at ST216) is instantly reflected on a display.

7. Operation Panel C7 for Correcting Positional Shift Over Time

It is a panel for displaying and manipulating the function r(t). When this panel is operated, a change in the function r(t) (at step ST217 and/or step ST218) is instantly reflected on a display.

On a reproduction control operation panel P52, a group of buttons capable of reproducing, stopping, fast forwarding, and quick returning the known acoustic signal are arranged so that it may be aurally checked. Through operations on the reproduction control operation panel P52, the interface 4 reproduces the known acoustic signal by the acoustic reproducing section included therein.

Next, the sub-window W3 for operating the acoustic signal s(t) after removal of the known acoustic signal can freely set the shape of the parameter function c(ω,t) in Equation (11). Each of the operation panels therein is described.

1. Operation Panel C8 for Graphic Equalizer (GEQ) (to the Right of Panel E8)

It is a panel (where the horizontal axis indicates the magnitude of the function, while the vertical axis indicates the frequency axis), for displaying and manipulating the shape of the function c(ω,t). The function c(ω,t) at the time t at the position of the cursor is plotted. The result of a setting operation is instantly reflected on the display panel E8 of the function c(ω,t). The magnitude of the value of the function c(ω,t) is indicated by shading on the panel E8 (in which the horizontal axis indicates the time axis, while the vertical axis indicates the frequency axis).

2. Volume Fader Operation Panel C9 (Below Panel E8)

It is the panel for displaying and manipulating the shape of the function c(ω,t) in the t direction. The result of a setting operation is instantly reflected on the display panel E8 of the function c(ω,t).

On a reproduction control operation panel P53, a group of buttons capable of reproducing, stopping, fast forwarding, and quick returning the synthesized acoustic signal (output of the synthesis means 7) are arranged so that the synthesized acoustic signal is aurally checked. Through operations on the reproduction control operation panel P53, the interface 4 reproduces the acoustic signal synthesized by the acoustic reproducing section included therein.

Next, implementation of this embodiment is described. First, when the mixed acoustic signal m(t) is observed, a program capable of obtaining an unknown signal s(t) was implemented on various operating systems (such as Linux 2.4, SGI IRIX 6.5, and Microsoft Windows XP: trademarks) under a condition in which the acoustic signal b′(t) corresponding to the original sound source of the acoustic signal b(t) is known. The mixed acoustic signal m(t) is constituted by the acoustic signal s(t) of a voice, sound, and the like with the acoustic signal b(t) of a BGM or the like added. When an audio file having the signals m(t) and b′(t) recorded therein is given to this program, the audio file of the signal s(t) can be obtained.

As a result of performing experiments on various mixed sounds each including a human voice and a sound with a background music (BGM) added therein, it was confirmed that, by using the acoustic signal of the original piece of the BGM, the BGM in each of the mixed sounds could be removed, and that the human voice and the sound could be thereby obtained. Even if pieces of various categories of music such as a piece with or without sounds of a drum, a piece of popular music, and a piece of classical music were included as BGM, the removal was possible.

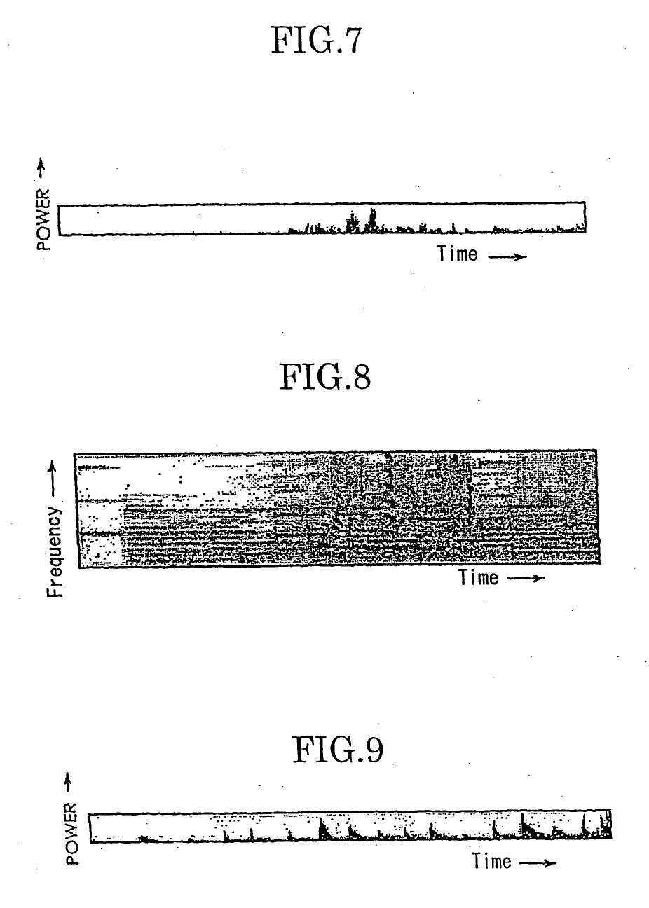

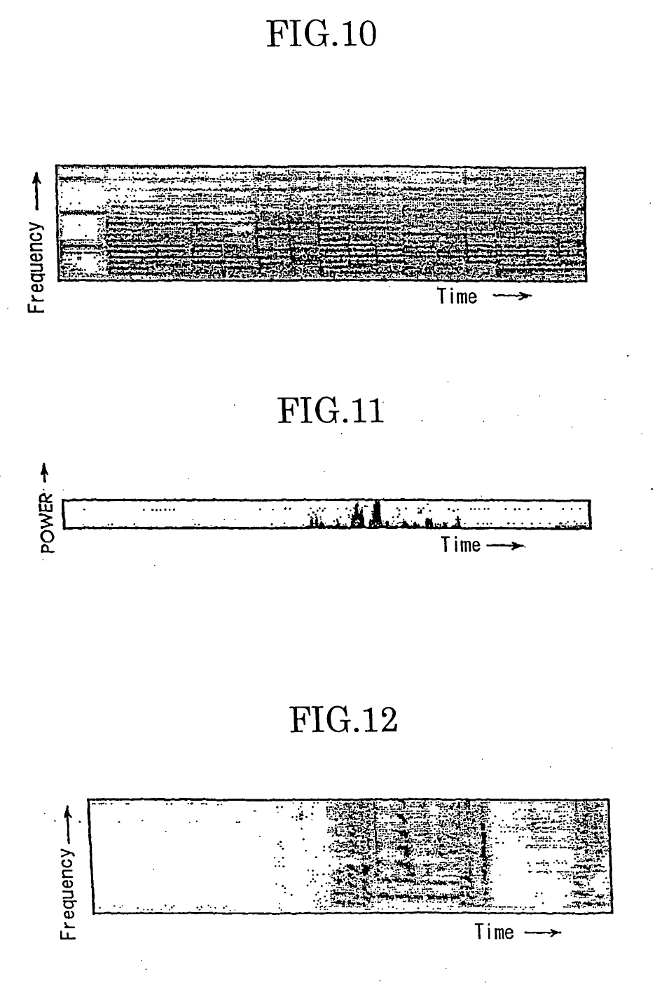

The results of actual processing of the mixed sound in which the classical music is played as BGM for a dialogue between a man and a woman is shown in FIGS. 7 to 12, as an example indicating a result of the experiment. A result is obtained by inputting a mixed acoustic signal m(t) shown in FIGS. 7 and 8, and using a known acoustic signal b′(t) from an original sound source shown in FIGS. 9 and 10 to remove a BGM component. The result is the acoustic signal s(t) after the removal of the mixed known acoustic signal, shown in FIGS. 11 and 12. In the mixed sound used for showing the example of the result of the processing, the acoustic signal of the classical music extracted from an “RWC study music database for study” is added to the acoustic signal indicative of the dialogue between the man and the woman, extracted from an “RWCP sound and conversation database”.

As described above, according to the present invention, by using a correction step in particular, the corrected amplitude spectrum of the known acoustic signal is obtained by correcting at least one of a positional shift over time, a temporal change in the frequency characteristic, a temporal change in the volume, and an expansion or a contraction in the time axis direction, and an expansion or a contraction in the frequency axis direction of the amplitude spectrum of the known acoustic signal in relation to the amplitude spectrum of the mixed acoustic signal. This corrected amplitude spectrum is removed from the amplitude spectrum of the mixed acoustic signal. Thus, an advantage can be obtained that the known acoustic signal included in the mixed acoustic signal as nonstationary noise can be removed with high accuracy.

When the acoustic signal in a TV program, a movie, or the like, with a BGM played in the background of a human voice and a sound therein, is input, the BGM in the program can be removed using the acoustic signal of the music of the BGM prepared separately, and the acoustic signal constituted by the human voice and the sound alone can be obtained.

Further, by providing other music as BGM with the acoustic signal after removal of the BGM, the TV program, movie, or the like can be reused by replacing music.

Since the known acoustic signal may be an arbitrary acoustic signal, the invention can be applied irrespective of the category of music, irrespective of the presence or absence of a vocalist, and the presence or absence of a musical accompaniment. The application of the invention is not limited to music, and the invention can be also applied to an arbitrary known noise including the stationary noise and the nonstationary noise.

1. A known acoustic signal removal method of removing a mixed known acoustic signal component from a mixed acoustic signal having a plurality of acoustic signals mixed therein, said method comprising:
a mixed acoustic signal transforming step of transforming the mixed acoustic signal into a time-frequency representation, thereby obtaining an amplitude spectrum of the mixed acoustic signal and a phase of the mixed acoustic signal;
a known acoustic signal transforming step of transforming a known acoustic signal corresponding to the mixed known acoustic signal included in the mixed acoustic signal into a time-frequency representation, thereby obtaining an amplitude spectrum of the known acoustic signal;
a correction step of obtaining a corrected amplitude spectrum of the known acoustic signal by correcting at least one of a positional shift over time, a temporal change in a frequency characteristic, a temporal change in a volume, an expansion or a contraction in a time axis direction, and an expansion or a contraction in a frequency axis direction of the amplitude spectrum of the known acoustic signal in relation to the amplitude spectrum of the mixed acoustic signal, based on the amplitude spectrum of the mixed acoustic signal;
a removal step of removing the corrected amplitude spectrum of the known acoustic signal from the amplitude spectrum of the mixed acoustic signal;
an inverse transforming step of performing an inverse transform into a time representation, based on the amplitude spectrum after removal obtained by said removal step and the phase of the mixed acoustic signal, thereby obtaining unit waveforms; and
a synthesis step of synthesizing the unit waveforms, thereby obtaining an acoustic signal from which the known acoustic signal component has been removed.

2. The known acoustic signal removal method according to claim 1, wherein in said correction step, a temporal position of the known acoustic signal included in the mixed acoustic signal is estimated; and
the positional shift over time of the amplitude spectrum of the known acoustic signal is corrected, based on the estimated temporal position.

3. The known acoustic signal removal method according to claim 1, wherein in said correction step, a temporal change in the frequency characteristic of the known acoustic signal included in the mixed acoustic signal is estimated; and
the temporal change in the frequency characteristic of the amplitude spectrum of the known acoustic signal is corrected, based on the estimated temporal change in the frequency characteristic.

4. The known acoustic signal removal method according to claim 1, wherein in said correction step, a temporal change in the volume of the known acoustic signal included in the mixed acoustic signal is estimated; and
the temporal change in the volume of the amplitude spectrum of the known acoustic signal is corrected, based on the estimated temporal change in the volume.

5. The known acoustic signal removal method according to claim 1, wherein in said correction step, an expansion or a contraction in the time axis direction of the known acoustic signal included in the mixed acoustic signal is estimated; and
the expansion or the contraction in the time axis direction of the amplitude spectrum of the known acoustic signal is corrected, based on the estimated expansion or the estimated contraction in the time axis direction.

6. The known acoustic signal removal method according to claim 1, wherein in said correction step, an expansion or a contraction in the frequency axis direction of the known acoustic signal included in the mixed acoustic signal is estimated; and
the expansion or the contraction in the frequency axis direction of the amplitude spectrum of the known acoustic signal is corrected, based on the estimated expansion or the estimated contraction in the frequency axis direction.

7. The known acoustic signal removal method according to claim 1, further comprising:
an image display step of displaying image so that the amplitude spectrum of the known acoustic signal can be visually contrasted with the amplitude spectrum of the mixed acoustic signal; and
an acoustic reproduction step of acoustically reproducing as sounds the mixed acoustic signal, the known acoustic signal, and an output signal resulting from said synthesis step;
wherein a segment with the known acoustic signal in the mixed acoustic signal included therein is manually specified, based on the image display and the acoustic reproduction; and
said correction step, said removal step, said inverse transforming step, and said synthesis step are executed on the segment.

8. The known acoustic signal removal method according to claim 1, wherein a segment with the known acoustic signal in the mixed acoustic signal included therein is automatedly estimated, based on the amplitude spectrum of the mixed acoustic signal; and
said correction step, said removal step, said inverse transforming step, and said synthesis step are executed on the segment.

9. The known acoustic signal removal method according to claim 1, wherein when a plurality of known acoustic signals is present corresponding to the mixed known acoustic signal included in the mixed acoustic signal,
said known acoustic signal transforming step and said correction step are executed on all of the known acoustic signals; and
said inverse transforming step and said synthesis step are executed using the amplitude spectrum after removal obtained by the removal step which removes all of corrected amplitude spectra of the known acoustic signals from the amplitude spectrum of the mixed acoustic signal.

10. The known acoustic signal removal method according to claim 1, wherein when said correction step is executed, an interface is employed, through which at least one of the corrections of the positional shift over time, the temporal change in the frequency characteristic, the temporal change in the volume, the expansion or the contraction in the time axis direction, and the expansion or the contraction in the frequency axis direction is manually specified.

11. The known acoustic signal removal method according to claim 10, wherein said interface includes an image display section for displaying image so that the amplitude spectrum of the known acoustic signal can be visually contrasted with the amplitude spectrum of the mixed acoustic signal; and
the corrections are manually specified, based on the image displayed by said image display section.

12. The known acoustic signal removal method according to claim 10, wherein said interface includes an acoustic reproducing section for reproducing as sounds the mixed acoustic signal, the known acoustic signal, and an output signal resulting from said synthesis step; and
the corrections are manually specified, based on the sounds reproduced by said acoustic reproducing section.

13. The known acoustic signal removal method according to claim 10, wherein said interface includes an image display section for displaying image so that the amplitude spectrum of the known acoustic signal can be visually contrasted with the amplitude spectrum of the known acoustic signal, and an acoustic reproducing section for reproducing as sounds the mixed acoustic signal, the known acoustic signal, and an output signal resulting from said synthesis step; and
the corrections are manually specified, based on the image displayed by said image display section and the sounds reproduced by said acoustic reproducing section.

14. A known acoustic signal removal device that removes a known acoustic signal component from a mixed acoustic signal having a plurality of acoustic signals mixed therein, said device comprising:
mixed acoustic signal transforming means for transforming the mixed acoustic signal into a time-frequency representation, thereby obtaining an amplitude spectrum of the mixed acoustic signal and a phase of the mixed acoustic signal;
known acoustic signal transforming means for transforming a known acoustic signal corresponding to the mixed known acoustic signal included in the mixed acoustic signal into a time-frequency representation, thereby obtaining an amplitude spectrum of the known acoustic signal;
correction means for obtaining a corrected amplitude spectrum of the known acoustic signal by correcting at least one of a positional shift over time, a temporal change in a frequency characteristic, a temporal change in a volume, an expansion or a contraction in a time axis direction, and an expansion or a contraction in a frequency axis direction of the amplitude spectrum of the known acoustic signal in relation to the amplitude spectrum of the mixed acoustic signal, based on the amplitude spectrum of the mixed acoustic signal;
removal means for removing the corrected amplitude spectrum of the known acoustic signal from the amplitude spectrum of the mixed acoustic signal;
inverse transforming means for performing an inverse transform into a time representation, based on the amplitude spectrum after removal obtained by said removal means and the phase of the mixed acoustic signal, thereby obtaining unit waveforms; and
synthesis means for synthesizing the unit waveforms, thereby obtaining an acoustic signal from which the known acoustic signal component has been removed.

15. The known acoustic signal removal device according to claim 14, wherein said correction means includes an interface which allows manual specification of at least one of the corrections of the positional shift over time, the temporal change in the frequency characteristic, the temporal change in the volume, the expansion or the contraction in the time axis direction, and the expansion or the contraction in the frequency axis direction.

16. The known acoustic signal removal device according to claim 15, wherein said interface includes an image display section for displaying image so that the amplitude spectrum of the known acoustic signal can be visually contrasted with the amplitude spectrum of the mixed acoustic signal, and an acoustic reproducing section for reproducing as sounds the mixed acoustic signal, the known acoustic signal, and an output signal of said synthesis means; and
said interface is so configured as to allow manual specification of a segment of the known acoustic signal included in the mixed acoustic signal, and at least one of the corrections of the positional shift over time, the temporal change in the frequency characteristic, the temporal change in the volume, the expansion or the contraction in the time axis direction, and the expansion or the contraction in the frequency axis direction of the amplitude spectrum of the known acoustic signal, based on the amplitude spectrum of the mixed acoustic signal and the amplitude spectrum of the known acoustic signal both displayed on said image display section, and the sounds reproduced by said acoustic reproducing section.

17. The known acoustic signal removal device according to claim 16, wherein said image display section is so constructed as to display the amplitude spectrum of the mixed acoustic signal in a segment including the mixed known acoustic signal and a corrected amplitude spectrum of the known acoustic signal in a segment corresponding to the segment including the mixed known acoustic signal with the amplitude spectrum of the mixed acoustic signal being aligned with the corrected amplitude spectrum of the known acoustic signal on a time axis,
the corrected amplitude spectrum being obtained by correcting at least one of the positional shift over time, the temporal change in the frequency characteristic, the temporal change in the volume, the expansion or the contraction in the time axis direction, and the expansion or the contraction in the frequency axis direction.

18. The known acoustic signal removal method according to claim 16, wherein said image display section is so constructed as to allow image display of the amplitude spectrum of the acoustic signal obtained by removing the amplitude spectrum of the corrected amplitude spectrum from the amplitude spectrum of the mixed acoustic signal.

19. A program for causing a computer to execute steps for removing a known acoustic signal component from a mixed acoustic signal having a plurality of acoustic signals mixed therein, said steps comprising:
a mixed acoustic signal transforming step of transforming the mixed acoustic signal into a time-frequency representation, thereby obtaining an amplitude spectrum of the mixed acoustic signal and a phase of the mixed acoustic signal;
a known acoustic signal transforming step of transforming a known acoustic signal corresponding to the mixed known acoustic signal included in the mixed acoustic signal into a time-frequency representation, thereby obtaining an amplitude spectrum of the known acoustic signal;
a correction step of obtaining a corrected amplitude spectrum of the known acoustic signal by correcting at least one of a positional shift over time, a temporal change in a frequency characteristic, a temporal change in a volume, an expansion or a contraction in a time axis direction, and an expansion or a contraction in a frequency axis direction of the amplitude spectrum of the known acoustic signal in relation to the amplitude spectrum of the mixed acoustic signal, based on the amplitude spectrum of the mixed acoustic signal;
a removal step of removing the corrected amplitude spectrum of the known acoustic signal from the amplitude spectrum of the mixed acoustic signal;
an inverse transforming step of performing an inverse transform into a time representation, based on the amplitude spectrum after removal obtained by said removal step and the phase of the mixed acoustic signal, thereby obtaining unit waveforms; and
a synthesis step of synthesizing the unit waveforms, thereby obtaining an acoustic signal from which the known acoustic signal component has been removed.

20. The program according to claim 19, wherein in said correction step, said computer is caused to execute:
estimation of a temporal position of the known acoustic signal included in the mixed acoustic signal and
correction of the positional shift over time of the amplitude spectrum of the known acoustic signal based on the estimated temporal position.

21. The program according to claim 19, wherein in said correction step, said computer is caused to execute:
estimation of a temporal change in the frequency characteristic of the known acoustic signal included in the mixed acoustic signal, and
correction of the temporal change in the frequency characteristic of the amplitude spectrum of the known acoustic signal based on the estimated temporal change in the frequency characteristic.

22. The program according to claim 19, wherein in said correction step, said computer is caused to execute:
estimation of a temporal change in the volume of the known acoustic signal included in the mixed acoustic signal, and
correction of the temporal change in the volume of the amplitude spectrum of the known acoustic signal based on the estimated temporal change in the volume.

23. The program according to claim 19, wherein in said correction step, said computer is caused to execute:
estimation of an expansion or a contraction in the time axis direction of the known acoustic signal included in the mixed acoustic signal, and
correction of the expansion or the contraction in the time axis direction of the amplitude spectrum of known acoustic signal based on the estimated expansion or the estimated contraction in the time axis direction.

24. The program according to claim 19, wherein in said correction step, said computer is caused to execute:
estimation of an expansion or a contraction in the frequency axis direction of the known acoustic signal in the mixed acoustic signal, and
correction of the expansion or the contraction in the frequency axis direction of the amplitude spectrum of the known acoustic signal based on the estimated expansion or the estimated contraction in the frequency axis direction.

25. The program according to claim 19, further causing said computer to execute an image display step of displaying image so that the amplitude spectrum of the known acoustic signal can be visually contrasted with the amplitude spectrum of the mixed acoustic signal.

26. The program according to claim 19, further causing said computer to execute an acoustic reproduction step of acoustically reproducing as sounds the mixed acoustic signal, the known acoustic signal, and an output signal resulting from said synthesis step.

27. The program according to claim 19, causing said computer to execute:
automated estimation of a segment in which the known acoustic signal is included in the mixed acoustic signal, based on the amplitude spectrum of the mixed acoustic signal; and
said correction step, said removal step, said inverse transforming step, and said synthesis step on the segment.

28. The program according to claim 19, wherein when a plurality of known acoustic signals is present corresponding to the mixed known acoustic signal included in the mixed acoustic signal, said computer is caused to execute:
said known acoustic signal transforming step and said correction step on all of the known acoustic signals; and
said inverse transforming step and said synthesis step using the amplitude spectrum after removal obtained by the removal step which removes all of corrected amplitude spectra of the known acoustic signals from the amplitude spectrum of the mixed acoustic signal.

29. The known acoustic signal removal method according to claim 17, wherein said image display section is so constructed as to allow image display of the amplitude spectrum of the acoustic signal obtained by removing the amplitude spectrum of the corrected amplitude spectrum from the amplitude spectrum of the mixed acoustic signal.
